(19) United States
(12) Patent Application Publication
(10) Pub. No.: US 2019/0184667 A1
(43) Pub. Date: Jun. 20, 2019

(54) HEAT PRESS MACHINE

(71) Applicant: Enetshops, LLC, Fullerton, CA (US)

(72) Inventor: Dawei Cao, Dongguan (CN)

(21) Appl. No.: 16/106,792

(22) Filed: Aug. 21, 2018

(30) Foreign Application Priority Data
Dec. 14, 2017 (CN) 2017217444390
Jan. 31, 2018 (CN) 2018201661857

(51) Int. Cl. B30B 15/00; B30B 15/06; B30B 1/04

(52) U.S. Cl. CPC B30B 15/0094; B30B 1/04; B30B 15/064

(57) ABSTRACT

The position adjusting indicator device for manual heat press machine, comprising a pedestal, and there is a fixed or sliding base plate on the upper plane pedestal, there assembles heating element on the upper plane of the base plate. The middle of the rear end of the pedestal connects to the rack, and on the middle of the rack installs the housing. A handle can be assembled on the near side of the housing; An arm can be assembled with position adjusting indicator device components below the handle. And the arm is installed on the heating element, one side of the arm is fixedly connected with the rack. The up and down of heating element is controlled by adjusting position indicator device in order to achieve accurate pressure. The heat press device utilizes manual position adjusting pressure to achieve accurate position and better transfer effect, which avoid the disadvantages that the traditional heat press machine can not accurately adjust the position and save adjusting position time.

The application discloses a pressure detection device for a manual heat press machine, which comprises a rack chassis, a lower column is installed on the upper end of the chassis bottom plate, the upper column is assembled on the upper end of the pressure sensor. The base plate is on the upper end of the upper column. The heating element is on the upper end of the base plate. And the hand-wheel is above the heating element. The handle is on the front of the hand-wheel. The controller is installed on the rack chassis. The pressure detection device of the manual heating press machine uses a pressure sensor to detect the pressure between the heating element and the base plate, it is directly reflected pressure value on the screen of controller, thereby it can achieve rapid pressure adjustment and avoid the disadvantages of slow adjustment speed and adjustable accuracy are not optimized problems of traditional machines. It enhances the adjusting detection structure and improves production efficiency. The overall structure is simple, easy to operate and fast to adjust.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 C.F.R. § 1.57.

### BACKGROUND OF THE INVENTION

### Field of the Invention

The application relates to the field of heat press machines that can have a manual position adjusting indicator device. The application also relates to heat press equipment, in particular to a pressure detecting device of a manual heat press machine.

### Description of the Related Art

At present, the existing heat press machine is easily adjusted. The device is operated by manually adjusting the upper and lower portions of a screw rod to achieve reduced or increased pressure. The above-mentioned device adjusted pressure manually and it cannot accurately know the pressure value or level.

At present, there is no suitable pressure detecting device for existing manual heat press machines. Typically manual heat press machines employ a pressure hand-wheel to adjust the working interval or require constant testing to confirm the required pressure. The adjusting method is slow, inaccurate and inconvenient to repeat setting the same pressure. Moreover, the above-mentioned device needs a lot of time to adjust the machine when transferring different materials subjects in a short time, otherwise the transfer effect cannot be achieved. Thus an improved heat press machine with pressure detecting device is needed.

### SUMMARY OF THE INVENTION

The purpose of a first version of the heat press device is to solve the above defects in prior art and to provide a pressure read-out device for a manual heat press machine which is simple in structure and convenient to use and can improve the efficiency of adjusting the pressure value or level.

To achieve the above objectives, the present invention provides the following technical solutions: a position adjusting indicator device for manual heat press machine, comprising a pedestal, and there is a fixed or sliding base plate on the upper plane pedestal. There are heating element assemblies on the upper plane of the base plate. The middle of the rear end of the pedestal connects to the rack. A housing is installed on the middle of the rack. A handle assembly is provided near a side of the housing. Position adjusting indicator device components and an arm are disposed below the handle. The arm is installed on the heating element. One side of the arm is fixedly connected with the rack.

Preferably, the position adjusting indicator device components include a hand-wheel, a position indicator and an adjusting screw. The hand-wheel is installed above the position indicator and is coupled with the adjusting rod.

Preferably, there is a pinboard on the middle of the upper heating element. The arm is fixed on the pinboard of the heating element.

Preferably, the housing encloses a controller for controlling time and temperature of the heat press.

Preferably, an adjusting screw nut is disposed on, e.g., welded in the middle of arm.

Preferably, the handle is coupled to the arm at a joint.

Compared with the prior art, heat presses disclosed herein have the below described advantages:

The heat presses can utilize manual position adjusting pressure to achieve accurate position and better transfer effect, which avoid the disadvantages that the traditional heat press machine can not accurately adjust the position and save adjusting position time; when the device is operated, the heating element is in open mode; Then adjusting setting time and temperature, placing the object needing to be transferred on the base plate, then covered by the transferring image. When the temperature reaches the setting value, pressing down the handle and the heating element closed. When the set time has been reached, the system automatically alarms, then manually pull the handle and heating element open, taking the transfer object to complete the operation. Its overall structure is simple and easy to operate, it can improve the precision of pressure adjustment during transfers.

The purpose of a second version of the heat press device is to solve the above defects in prior art and to provide a pressure detecting device for a manual heat press machine. The device is simple in structure and convenient to use and can improve the efficiency of adjusting the machine. It can solve the current issue of slow pressure adjustment speed, inaccurate pressure and inconsistency in setting the same pressure value during each pressing cycle.

To achieve the above objectives, the present invention provides the following technical solutions: a pressure detecting device for manual heat press machine comprises a rack chassis, a lower column is installed on the upper end of the rack chassis bottom plate, and the lower column is fixed to the rack chassis via nuts; the pressure sensor is installed on the upper end of the lower column. An upper column is on the upper end of the pressure sensor. The base plate is above the upper column. The heating element is above the base plate. The bottom end of the base plate is fixed and connected with the upper column. The bottom end of the heating element is fixed and connected with the upper base plate. The upper end of the heating element is provided with a hand-wheel. The front end of the hand wheel is provided with a handle. The rack chassis is assembled with a controller. The controller is mounted on the right side of the rack chassis.

Preferably, the front end of the pressure sensor is connected with the base plate through the upper column. The rear end of the pressure sensor is connected with the rack chassis through the lower column.

Preferably, the upper and lower sides of the pressure sensor are provided with a detection circuit, and the detection circuit is encapsulated with silicone grease.

Compared with the prior art, the heat presses disclosed herein have the below advantages:

The pressure detection device of the manual heat press machine uses a pressure sensor to detect the pressure between the heating plate and the base plate, and is directly reflected on the controller screen. Thereby it can achieve rapid pressure adjustment, avoiding the disadvantages of slow adjustment speed and pressure adjustment accuracy problems of traditional machines. It enhances the adjusting detection structure and improves production efficiency. When operating the machines, the heating element is in the open state, pressing down the handle to make the heating element contact the silicone pad of the base plate and adjusting the handle-wheel to a suitable pressure value, then testing the samples to achieve the best transfer effect. When changing to another transfer material, adjusting the height of the handle-wheel, choosing the proper pressure value and testing samples can be done until the best transfer effects are achieved. When transferring different materials, quick change can be achieved and time spent adjusting machine can be saved. The overall structure is simple, easy to operate and fast to adjust.

### BRIEF DESCRIPTION OF THE DRAWINGS

FIG. 1 is a schematic view of the overall structure of an embodiment of the heat press device.

FIG. 2 is a schematic structural view of the arm components of an embodiment of the heat press device.

FIG. 3 is a perspective view of an embodiment of the heat press device position adjusting indicator;

FIG. 4 is a perspective view of an embodiment of the heat press device.

FIG. 5 is a front view of an embodiment of the heat press device.

FIG. 6 is a side view of an embodiment of the heat press device.

### DETAILED DESCRIPTION OF THE PREFERRED EMBODIMENT

The following describes clearly the technical solutions for embodiments of the first version of the heat press device with reference to the accompanying drawings in the present application. The described embodiments are merely a part of the embodiments of the present invention, not inclusive of all implementation examples. Based on the embodiments of the present invention, any other embodiments obtained by the technician without making creative efforts shall fall within the protection scope of the present invention.

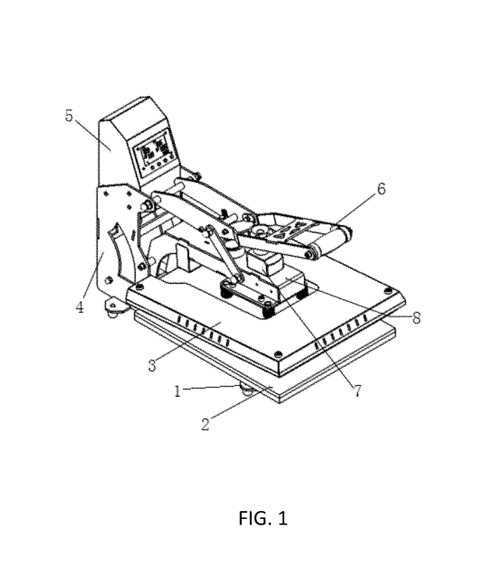

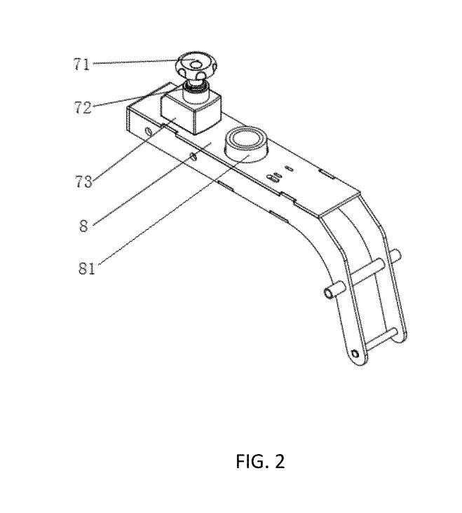

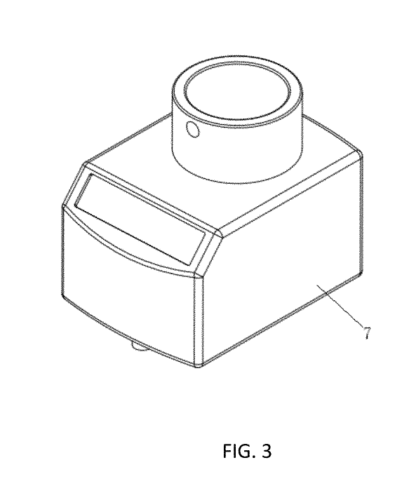

Referring to FIGS. 1-3, a position indicator device for manual heat press machine, which includes pedestal 1, the upper plane is provided with a fixed or sliding base plate 2 on the up pedestal. The upper plane of the base plate 2 is installed with heating element 3. The rear end of the pedestal 1 can connect with the rack 4. The housing 5 can be installed in the middle of the rack 4. The housing 5 can be provided with time and temperature control table system. The time and temperature control system is used to control the heating temperature and the transfer time of the heating element 3. The rack 4 close to the housing side connects with handle 6. The manual position adjusting indicator components 7 and arm can be assembled below the handle 6. The manual position adjusting indicator components 7 connects with arm 8. The arm 8 can be installed on heating element 3, and the other side can be fixed on rack 4. There is a pinboard on the middle of the upper heating element 3, The arm 8 can be fixed on the pinboard of the heating element. Adjusting screw nut 81 can be welded in the middle of the arm. The position adjusting indicator device components 7 include five-star 71 handle-wheel, position indicator device 72 and adjusting rod 73. The five-star hand-wheel 71 is installed above the position adjusting indicator 72 through the adjusting rod 73. The position adjusting indicator 72 value changes through the five star handle-wheel 71.

A position indicator device for manual heat press machine can include pedestal (1). The plate can be provided with a fixed or sliding base plate (2) on the upper pedestal. The upper plane of the bottom plate can be installed with heating element (3). The rear end of the pedestal (1) can connect with the rack (4). The rack (4) can be close to the housing connects with handle (6). The manual position adjusting indicator components (7) and arm can be assembled below the handle (6). The manual position adjusting indicator components (7) connect with arm (8). The arm (8) can be installed on the heating element (3), and the other side can be fixed on the rack.

Working principle: The position indicator device for manual heat press machine, uses position indicator device 7 to control the lifting and pressing of the heating element 3 to achieve a better transfer effect. This will avoid the disadvantages of the conventional position indicator 72, such as not being able to accurately adjust pressure. This can also save the position adjustment time. When the machine is working, the heating element 3 is in the open state, the housing 5 encloses a controller for controlling the setting time and the parameters of the temperature control table, then the transfer material to be transferred is placed on the base plate 2, covering the by printed picture. When the temperature reaches the set value, manual handle 6 can be pressed down and the heating element 3 will close, and transfer will start. After the transfer time reached the set value, the system automatically alarms, manually raising handle 6 up, and the heating plate 3 is in the open state, take the material away, thus the transfer is finished. Repeating the above process, it will achieve continuous operation.

Although the embodiments of the first version of the heat press device have been shown and described, it will be understood by those of ordinary skill in the art that various changes may be made in these embodiment without departing from the principles of the invention. Modifications, alternatives and variations, the scope of the present invention being defined by the appended claims and their equivalents.

The following describes clearly the technical solutions for the embodiments of the second version of the heat press device with reference to the accompanying drawings in the present application. The described embodiments are merely a part of the embodiments of the present invention, not inclusive of all implementation examples. Based on the embodiments of the present invention, any other embodiments obtained by those technician without making creative efforts shall fall within the protective scope of the present invention.

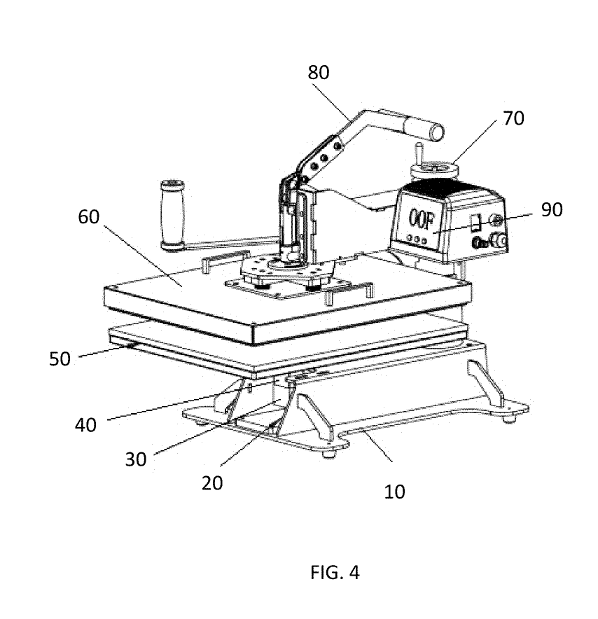

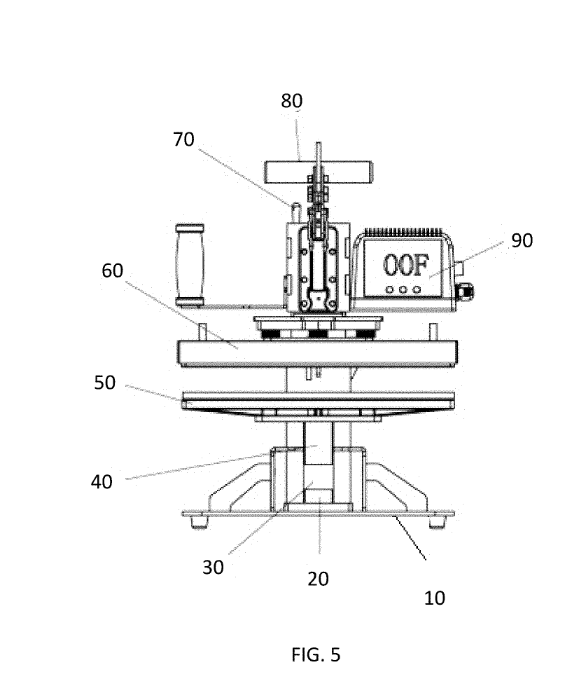

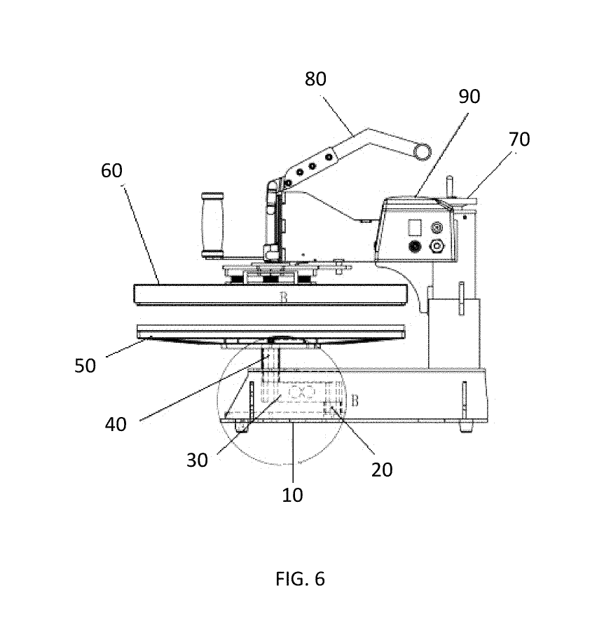

Referring to FIGS. 4-6, the pressure detection device for a manual heat press machine includes a rack chassis 10, the lower column is installed on the upper end of the rack chassis 10, the lower column is fixedly connect with the rack chassis 10 through nuts. The pressure sensor 30 is installed on the upper end of the lower column 20. The upper end of the pressure sensor 30 is the upper column 40. The upper and lower sides of the pressure sensor 30 are provided with a detection circuit, and the detection circuit is encapsulated with silicone grease. The upper end of upper column 40 is provided with a base plate 50; The front end of the pressure sensor 30 is connected with the base plate 50 through the upper column 40, and the rear end of the pressure sensor 30 is connected with the rack chassis 10 through the lower column 20. And the upper end of the base plate 50 is heating element 60. The bottom end of the base plate 50 is fixedly connected with the upper column 40. The bottom end of the heating element 60 is fixedly connected with the upper base plate 50. The upper end of the heating element 60 is provided with a hand-wheel 70, the front end of the hand wheel 70 is provided with a handle 80. The rack chassis 10 is assembled with the controller 90. And controller 90 is fixedly mounted on the right side of the rack chassis 10. The pressure sensor 30 of the pressure detection device, wherein generates an electrical signal by detecting a pressure transmitted by the deformation of the base plate 50, which detects the pressure between the heating element 60 and the base plate 50, and it is directly reflected on the screen of controller 90, thereby it can achieve rapid pressure adjustment and avoid the disadvantages of slow adjustment speed and adjustment accuracy problems of the traditional machines. It enhances the adjusting detection structure and improves production efficiency. When operating the machines, the heating element 60 is in the open state, pressing down the handle 80 to make the heating element 60 contact the silicone pad of base plate 50 and adjusting the handle-wheel 70 to suitable pressure value, then testing the samples until the best transfer effect is achieved. When changing to various transfer materials, it can achieve quick change and save time in adjusting the machine.

In conclusion, the pressure detection device of the manual heat press machine uses the pressure sensor 30 to detect the pressure between the heating element 60 and the base plate 50 is directly reflected on the display screen of the controller 90 to directly read out, thereby it can achieve rapid pressure adjustment and avoid the disadvantages of slow adjustment speed and adjustable accuracy not being optimized—problems of the traditional machines. It enhances the adjusting detection structure and improves production efficiency. When operating the machines, the heating element 60 is in the open state, pressing down the handle 80 to make the heating element 60 contact the silicone pad of the base plate 50 and adjusting the handle-wheel 70 to suitable pressure value, then testing the samples to achieve the best transfer effect. When changing to another sublimation material, adjusting the height of the handle-wheel 70, choosing the proper pressure value and testing samples until the best transfer effects are achieved. When transferring different materials, it can achieve quick change and save time spent on adjusting the machine. The overall structure is simple, easy to operate and fast to adjust.

Although the embodiment of the present invention has been shown and described, it will be understood by those of ordinary skill in the art that various changes may be made in these embodiment without departing from the principles of the invention. Modifications, alternatives and variations, the scope of the present invention being defined by the appended claims and their equivalents.

What is claimed is:

1. A position indicator device for a manual heat press machine, comprising:
a pedestal;
a fixed or sliding bottom plate on the pedestal;
a heating element disposed on an upper portion of the bottom plate;
a rear end of the pedestal connected with a rack;
a handle coupled with the rack; and
a manual position adjusting indicator component and an arm disposed below the handle, wherein the manual position adjusting indicator component is connected with the arm, and wherein the arm has a first portion supporting a heating element and a second portion coupled with rack.

2. The position indicator device for a manual heat press of claim 1, wherein the manual position adjusting indicator components comprises a hand-wheel, a position indicator and an adjusting screw rod, wherein the hand-wheel disposed above the position indicator through a pressure adjusting rod.

3. The position indicator device for a manual heat press of claim 1, further comprising a pinboard on the middle of the upper heating element, wherein the arm is coupled to the pinboard of the heating element.

4. The position indicator device for a manual heat press of claim 1, further comprising a control box having a time and temperature control system.

5. The position indicator device for a manual heat press of claim 1, wherein an adjusting screw nut is coupled with the middle of arm.

6. The position indicator device for a manual heat press of claim 1, further comprising a link to join the handle to the arm.

7. A pressure detection device for a manual heat press machine, comprising:
a rack chassis;
a lower column, wherein the lower column is installed on the upper end of the rack chassis, and wherein the lower column is fixedly connected with the rack chassis through nuts;
a pressure sensor installed on the upper end of the lower column;
an upper column, wherein the upper end of the pressure sensor is the upper column;
a bottom plate, wherein the upper end of upper column is provided with the bottom plate;
a heating element, wherein the upper end of the bottom plate is the heating element, wherein the bottom end of the bottom plate is fixedly connected with the upper column, and wherein the bottom end of the heating element is fixedly connected with the upper bottom plate;
a hand-wheel, wherein the upper end of the heating element is provided with the hand-wheel;
a handle, wherein the front end of the hand wheel is provided with the handle; and
a controller, wherein the rack chassis is assembled with the controller; and the controller is fixedly mounted on the right side of the rack chassis.

8. The pressure detection device for a manual heat press machine of claim 7, further comprising:
a front end of the pressure sensor, wherein the front end of the pressure sensor is connected with the bottom plate through the upper column; and a rear end of pressure sensor, wherein the rear end of the pressure sensor is connected to the rack chassis through the lower column.

9. The pressure detection device for a manual heat press machine of claim 7, further comprising:
an upper side of the pressure sensor;
a lower side of the pressure sensor; and
a detection circuit, wherein the detection circuit is provided on the upper and lower sides of the pressure sensor, and wherein the detection circuit is encapsulated with silicone grease.
